(19) United States
(12) Patent Application Publication
(10) Pub. No.: US 2025/0272216 A1
(43) Pub. Date: Aug. 28, 2025

(54) METHOD AND DEVICE WITH FAULT ELEMENT DETERMINATION

(71) Applicant: SAMSUNG ELECTRONICS CO., LTD., Suwon-si (KR)

(72) Inventors: Dohwan LEE, Suwon-si (KR); Do-Ha HWANG, Suwon-si (KR); Jongseok KIM, Suwon-si (KR); Sungjoo GO, Suwon-si (KR); Changyong SON, Suwon-si (KR); Jaeyoon LEE, Suwon-si (KR)

(73) Assignee: SAMSUNG ELECTRONICS CO., LTD., Suwon-si (KR)

(21) Appl. No.: 18/782,494

(22) Filed: Jul. 24, 2024

(30) Foreign Application Priority Data
Feb. 23, 2024 (KR) 10-2024-0026336

(51) Int. Cl. G06F 11/36

(52) U.S. Cl. CPC G06F 11/3608; G06F 11/3688

(57) ABSTRACT

A method performed by an electronic device includes: executing a program corresponding to source code, the program including instructions including programming elements, the executing based on a test case; determining a rule-based first ranking of fault probability of the respective programming elements, based on whether the test case passes and based on whether each programming element is executed; determining a machine learning-based second ranking of the programming elements based on a result of applying a machine learning model to element features of the respective programming elements; and determining, from among the programming elements, a fault element, the determining based on a result of combining the rule-based first ranking with the machine learning-based second ranking, wherein the combining is based on a fault feature of a fault occurring in the execution of the program.

### CROSS-REFERENCE TO RELATED APPLICATIONS

This application claims the benefit under 35 USC § 119 (a) of Korean Patent Application No. 10-2024-0026336, filed on Feb. 23, 2024, in the Korean Intellectual Property Office, the entire disclosure of which is incorporated herein by reference for all purposes.

### BACKGROUND

### 1. Field

The following description relates to determining a fault element among programming elements.

### 2. Description of Related Art

In a software continuous integration (CI) process, when a developer changes the source code for a software implementation or modification and commits the changed source code to a code repository, a verification system linked to a CI platform may verify the integrity of the changed code by automatically performing a test case.

When the verification system discovers a fault in a testing process, the verification may notify the developer. When the developer analyzes the cause and location of the fault and modifies and commits the code again, the verification may be repeated.

A functional or minimum unit of modification is generally recommended for a commit of a source code, however, in practice, the scale of commits tend to be large in many cases due to frequent code changes.

Because of this, when a source code fault occurs after a commit of a large code modification, a significant amount of time is often required to designate a person responsible for fixing the code fault and it may take significant time for the designated person to identify a cause of the source code fault.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method performed by an electronic device includes: executing a program corresponding to source code, the program including instructions including programming elements, the executing based on a test case; determining a rule-based first ranking of fault probability of the respective programming elements, based on whether the test case passes and based on whether each programming element is executed; determining a machine learning-based second ranking of the programming elements based on a result of applying a machine learning model to element features of the respective programming elements; and determining, from among the programming elements, a fault element, the determining based on a result of combining the rule-based first ranking with the machine learning-based second ranking, wherein the combining is based on a fault feature of a fault occurring in the execution of the program.

The determining the rule-based first ranking may include: determining rule-based probability scores representing the probabilities that respective programming elements have a fault, based on whether the test case passes and whether the programming element is executed; adjusting the rule-based probability scores of the respective programming elements based on a result of the execution of the program; and determining the rule-based first ranking by sorting the adjusted rule-based possibility scores.

The adjusting the rule-based possibility scores may include: when the test case fails to pass for a programming element, increasing the rule-based probability score of the programming element corresponding to a function that is indicated by a call stack of the program.

The adjusting the rule-based probability scores may include: when the test case fails to pass, increasing a rule-based probability score of a programming element that corresponds to a termination point of the test case.

The adjusting the rule-based probability scores may include: when the test case fails to pass, increasing a rule-based possibility score of a programming element that is changed compared to a previous version of the program.

The determining the machine learning-based second ranking may include: obtaining element features of the programming elements, respectively; inferring machine learning-based probability scores of the respective programming elements, wherein each machine learning-based probability score represents the probability that a corresponding programming element has a fault and is generated by applying the corresponding element feature to the machine learning model; and determining the machine learning-based second ranking by sorting machine learning-based possibility scores.

Each of the element features may include: an indication of a change history of the corresponding programming element, a probability that the corresponding programming element has a fault in a previous version of the program, a call distance between the corresponding programming element and another programming element, an indication of whether the corresponding programming element is executed in the execution of versions of the program, or a rule-based probability score of the corresponding programming element.

The combining may include: determining a first weight for the rule-based first ranking and a second weight for the machine learning-based second ranking; and determining an ensemble-based third ranking of the programming elements by combining the rule-based first ranking and the machine learning-based second ranking according to the first and second weights.

The second weight may depend on a number of versions from a version where the fault newly occurs to a current version among versions of the program.

The determining the first weight and the second weight may include: determining a fault type of the fault among candidate fault types; and determining a weight pair mapped to the determined fault type to the first weight and the second weight.

The executing the program may include: changing the source code and updating a version of the program in response to receiving a change request for the source code; and executing the program based on the test case after changing the source code, and the determining the rule-based first ranking includes: determining the rule-based first ranking for the updated version of the program in response to the test case failing to pass, and the determining the machine learning-based second ranking includes: determining the machine learning-based second ranking for the updated version of the program in response to at least one test case failing to pass.

The method may further include: determining the rule-based first ranking, the machine learning-based second ranking, and the fault element in response to receiving an error report for an error occurring in the program from an external device using the program; outputting information on the determined fault element; changing the source code and updating a version of the program based thereon; verifying the updated version of the program; and distributing information on the updated version of the program to the external device, based on success in verifying the updated version of the program.

A non-transitory computer-readable storage medium may store instructions that, when executed by a processor, cause the processor to perform any of the methods.

In another general aspect, an electronic device includes one or more processors configured to: execute a program corresponding to source code, the program including programming elements, the executing based on a test case, determine rule-based first ranking of fault probabilities of the programming elements, based on whether the test case passes and based on whether each programming element is executed, determine a machine learning-based second ranking of the programming elements based on a result of applying a machine learning model to element features of the respective programming elements, and determine, from among the programming elements, a fault element,, the determining based on a result of combining the rule-based first ranking with the machine learning-based second ranking, wherein the combining is based on a fault feature of a fault occurring in the execution of the program.

The one or more processors may be further configured to determine rule-based probability scores representing the probabilities that programming elements have a fault, based on whether the test case passes and whether the programming element is executed, adjust the rule-based probability scores of the respective programming elements based on a result of the execution of the program, and determine the rule-based first ranking by sorting the adjusted rule-based probability scores.

The one or more processors may be further configured to obtain element features of the programming elements, respectively, by inferring machine learning-based probability scores of the respective programming elements, wherein each machine learning-based probability score represents the probability that a programming element has a fault and is generated by applying the corresponding element feature to the machine learning model, and determine the machine learning-based second ranking by sorting machine learning-based probability scores.

The one or more processors may be further configured to determine a first weight for the rule-based first ranking and a second weight for the machine learning-based second ranking, and determine an ensemble-based third ranking of the programming elements by combining the rule-based first ranking and the machine learning-based second ranking according to the first and second weights.

The second weight may depend on a number of versions from a version where the fault newly occurs to a current version among versions of the program.

The one or more processors may be further configured to change the source code and update a version of the program in response to receiving a change request for the source code, execute the program based on the test case after changing the source code, determine the rule-based first ranking for the updated version of the program in response to the test case failing to pass, and determine the machine learning-based second ranking for the updated version of the program in response to at least one test case failing to pass.

The one or more processors may be further configured to determine the rule-based first ranking, the machine learning-based second ranking, and the fault element in response to receiving an error report for an error occurring in the program from an external device using the program, output information on the determined fault element, change the source code and update a version of the program based thereon, verify the updated version of the program, and distribute information on the updated version of the program to the external device, based on success in verifying the updated version of the program.

Other features and aspects will be apparent from the following detailed description, the drawings, and the claims.

### BRIEF DESCRIPTION OF THE DRAWINGS

FIG. 1 illustrates an example of a program change, according to one or more embodiments.

FIG. 2 illustrates an example method of determining a fault element, according to one or more embodiments.

FIG. 3 illustrates an example of determining a rule-based first rank, according to one or more embodiments.

FIG. 4 illustrates an example of determining a machine learning-based second rank, according to one or more embodiments.

FIG. 5 illustrates an example configuration of an electronic device, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

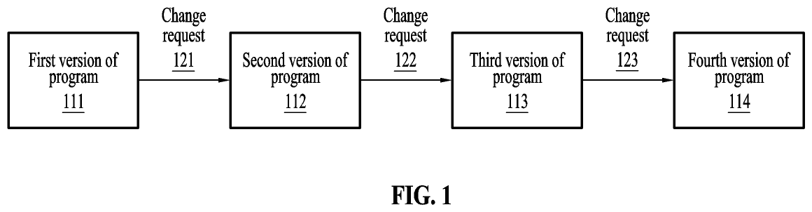

FIG. 1 illustrates an example of a program change, according to one or more embodiments. Specifically, FIG. 1 shows a cycle of repeated program revisions.

An electronic device, when a program is changed, may detect a fault of the changed program and may provide information on the detected fault to a user (e.g., a developer or a programmer).

The program, a computer program, may consist of a set of operations performable by the electronic device (or a processor).

The program may be expressed by source code of a programming language that describes the operations. The programming language may be a high-level language comprehensible by a person, an intermediate language, a machine language processible by a machine (e.g., the processor), or an assembly language at an intermediate level between the high-level language and the machine language.

The source code of the program describes the operations of the program in the grammar and syntax of the high-level language. The user (e.g., the developer or the programmer) may generate, change, and/or delete the source code written in the high-level language. A binary file of the program may be generated by compiling the source code of program into machine language code, intermediate code, or the like. Multiple users (e.g., developers or programmers) may generate, change, and/or delete the source code of the program. Information (e.g., information on the source code) on the program may be stored in a central repository (e.g., a server) and may be changed by the users who may access the central repository. An update of the program in an environment where the plurality of users may change the information on the program stored in the central repository may also be expressed by a continuous integration (CI) process. Typically, a user checks out a portion of source code (e.g., one or more files) from the central repository, makes changes to the portion of the source code, and checks the portion of the source code back in to the central repository. The central repository may manage the checking in and out of code to prevent two users from changing the same source code at the same time.

The electronic device, by executing the compiled program, may perform the operations instructed by the source code of the program. The processor executing the program translate the source code in the high-level language into binary file (or an execution file) in the machine language and performing the operations instructed by the program based on the binary file.

For example, the translating of the source code into the binary file may include the compiling of the source code in the high-level language through a compiler or an interpreter.

Referring to FIG. 1, a first version of the program 111 may correspond to a first state of the source code of the program. The electronic device may obtain a first change request 121 for the source code of the program. In various embodiments of the present disclosure, a change request may also be expressed by a commit, e.g., a request to the central repository (also known as a code repository or code management system). Change requests, e.g., the first change request 121, a second change request 122, and a third change request 123, may change the same or different portions of the source code of the program.

In response to the first change request 121, the electronic device may obtain and/or store a second state of the source code by changing at least a portion of the source code in its first state. The electronic device may set (e.g., change or update) a version of the program corresponding to the second source code to a second version of the program 112. In other words, the electronic device may store the second version of the program corresponding to the second source code.

In response to a change of a program version or a change of at least a portion of the source code thereof, the electronic device may verify a changed version of the program. The verifying of the changed version of the program may involve determining whether the program has a fault. For example, the electronic device may verify the program based on whether an error occurs while executing the changed version of the program. The electronic device, when detecting an error while executing the changed program, may determine that the verification of the program failed. When an error does not occur while executing the program, the verification of the program may be determined to have succeeded.

As noted, the electronic device may detect whether an error occurs while executing the program. For example, the electronic device may execute the program based on a test case, e.g. using test data, to execute the program. The test case may be a case used for verifying the program. For example, the case may designate a value of input data and/or configuration of the program that is input to the execution of the program. A test case may designate a hyperparameter (or a parameter) used for executing the program. The electronic device, while executing the program based on multiple test cases, may monitor whether an error occurs. When one of the test cases fails to pass, it may be determined that an error has occurred and the electronic device may determine that the verification of the program has failed. When all the test cases pass, it may be determined that an error has not occurred and the program may thus be verified.

When the electronic device detects an error while executing the second version of the program 112, the electronic device may determine (e.g., estimate or predict) a portion of the source code corresponding to a fault of the second version of the program 112. The electronic device may provide the user with information identifying the faulty portion. The electronic device may obtain the second change request 122. The user (e.g., the developer or the programmer) (or a user terminal) may generate a change request for at least a portion of the source code of the program with reference to information on the portion that has been determined to have a fault. If the first version of the program 111 has a fault, and the second version of the program 112 does not have a fault, the first change request 121 may also be expressed by (identified as) a bug inducing commit (BIC), i.e., a change request that induced a fault.

The electronic device, in response to the second change request 122, by changing at least a portion of the second source code, may obtain and/or store a third state of the source code. The electronic device may set a version of the program corresponding to the third source code to a third version of the program 113. In other words, the electronic device may store the third version of the program 113 corresponding to the third source code. The electronic device, based on a change of at least a portion of the source code of the program, may verify the third version of the program 113. Referring to FIG. 1, for example, the electronic device, based on the test case, may detect an error while executing the third version of the program 113 and may determine/identify a portion of the third source code responsible for the fault. The determining of the faulty portion of the source code may also be expressed by fault localization.

The electronic device, in response to the third change request 123, by changing at least a portion of the third source code, may obtain and/or store a fourth source code. The electronic device may set a version of the program corresponding to the fourth source code to a fourth version of the program 114. In other words, the electronic device may store the fourth version of the program 114 corresponding to the fourth source code. The electronic device, based on a change of at least a portion of the source code of the program, may verify the fourth version of the program 114. Referring to FIG. 1, for example, the electronic device, based on the test case, may not detect an error while executing the fourth version of the program 114. If the third version of the program 113 has a fault, and the fourth version of the program 114 does not have a fault, the change request 123 may also be determined to be a bug fixing commit (BFC), i.e., a change request that fixed a fault.

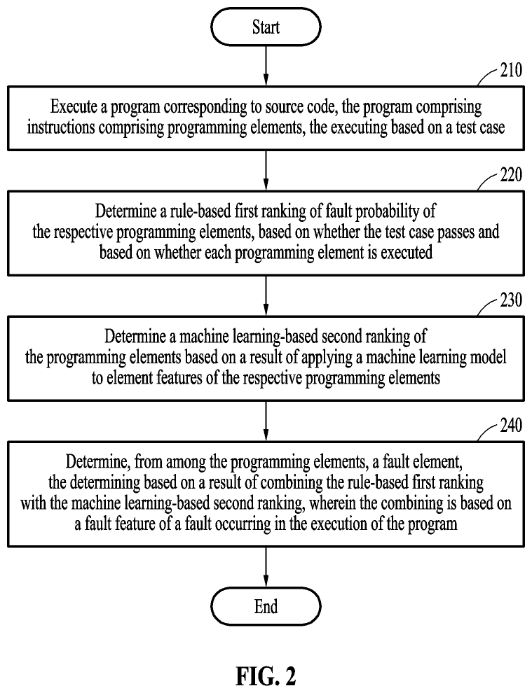

Methods of the electronic device determining a portion having a fault of the source code of a program is described with reference to FIGS. 2 to 4.

FIG. 2 illustrates an example of determining a fault element, according to one or more embodiments.

In operation 210, the electronic device executes a program corresponding to a source code including multiple programming elements. The execution may be based on a test case.

A programming element may be various units or portions of the source code of the program. For example, a programming element may be a file, a function, a line of the source code, a module, an object, and so forth.

As described above, the test case may be an execution scenario for verifying the program. For example, the electronic device may execute the program based on the test case by inputting a value of input data indicated by the test case to the program. For example, the electronic device may execute the program based on the test case by applying (e.g., substituting) a value of a hyperparameter (or a parameter) indicated by the test case to a hyperparameter (or a parameter) of the program.

In operation 220, the electronic device may determine a rule-based fault probability ranking (i.e., a first ranking) for fault probabilities of the respective programming elements, and may determine such a ranking based on tracking, for multiple test cases and multiple programming elements, which programming elements were executed by which test cases whether the test cases passed.

The fault probability of a programming element is the probability that the programming element has a fault. A ranking (e.g., a rule-based ranking) of programming elements may be in an order from the programming elements with the highest fault probabilities to the programming elements with the lowest fault probabilities. A ranking (e.g., the rule-based first ranking, a machine learning-based second ranking, or an ensemble-based third ranking) of N programming elements may have N rank values. The N rank values may respectively correspond to the N programming elements. Each rank value may have a value corresponding to how high the probability is that a corresponding programming element has a fault. For example, each rank value may be an integer value, from 1 to N, indicating the probability rank of the corresponding programming element.

A programming element that has a fault may be a programming element that, when the programming element is executed, causes an error to occur in the execution of the program. If a programming element has a fault, the error may or may not occur every time the programming element is executed. For example, a programming element may have a fault occur from execution of the program for only some of the cases among the cases.

When the program is executed, whether any given programming element is actually executed may depend on which test case is being used. Any given programming element may invoke a certain operation of the electronic device, and whether the given programming element is executed may control whether the electronic device executes the certain operation.

For example, when a value of input data of a first test case satisfies a first condition, a first programming element of the program may be executed, and a second programming element of the program may not be executed. When a value of input data of a second test case satisfies a second condition (or does not satisfy the first condition), the first programming element of the program may not be executed, and the second programming element of the program may be executed. That is to say, depending on the test case, some programming elements may or may not be executed.

If the first programming element has a fault, the first test case may fail (the program does not pass) since the faulty first programming element is executed, and yet the second test case may pass since the first programming element is not executed by the second test case. For a given programming element, as the number of test cases that both pass and execute the given programming element increases, and/or, as the number of test cases that fail (do not pass) without executing the given programming element decreases, among all the test cases, the fault probability of the given programming element may decrease. On the contrary, for a given programming element, as the number of test cases that both fail (do not pass) and execute the given programming element increases, and/or, as the number of test cases that pass without executing the programming element decreases, the fault probability of the given programming element may increase. This may apply to some or all of the programming elements.

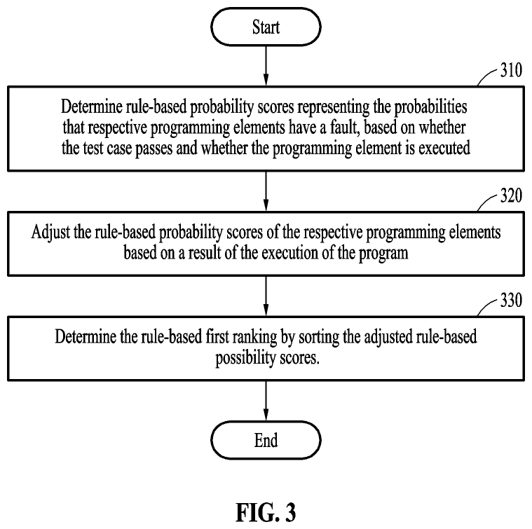

As such, based on whether a test case passes and whether a programming element is executed, a rule-based probability score representing the fault probability of the programming element may be determined. Given such probability scores for each of the respective programming elements, a rule-based fault probability ranking (for the fault probabilities) of the programming elements may be determined. Determining the rule-based fault probability ranking (also referred to as a “first ranking”) is described with reference to FIG. 3.

In operation 230, the electronic device may determine a machine learning-based second fault probability ranking based on a result of applying a machine learning model to element features representing features of the programming elements.

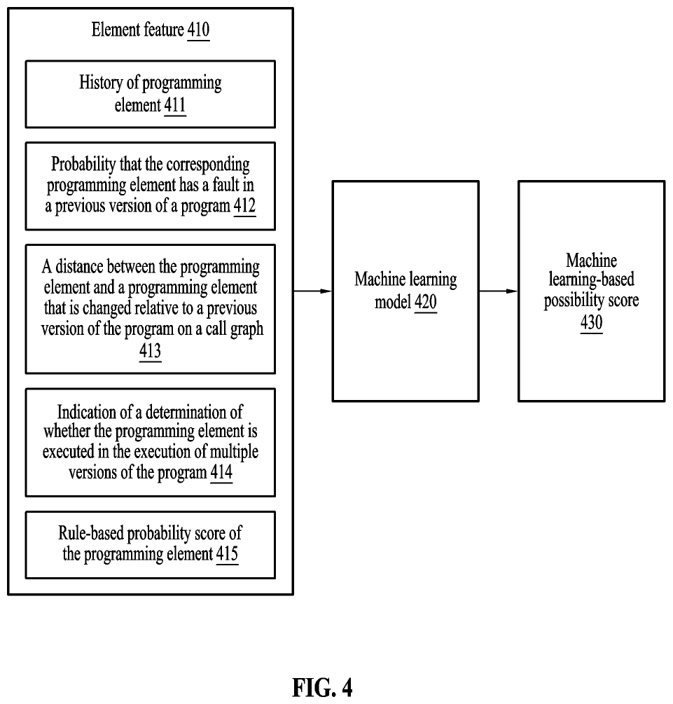

The machine learning model may be a model (e.g., a neural network) that is generated and/or trained to output/infer the fault possibility of a programming element from an element feature of the programming element. For example, the electronic device may obtain inferred output data corresponding to a possibility score representing the fault possibility of the programming element by applying the machine learning model to input data corresponding to the element feature of the programming element. According to an embodiment, the machine learning model may be implemented based on a neural network. The element feature is described with reference to FIG. 4.

The electronic device may obtain an element feature representing a feature of a programming element for each of the programming elements. For each programming element, the electronic device may output a machine learning-based probability score representing the probability that the programming element has a fault by applying an element feature of the programming element to the machine learning model. Machine learning-based probability scores may be obtained this way for each programming element. The electronic device may determine the machine learning-based second fault probability ranking by sorting machine learning-based probability scores of the programming elements. Like the rule-based first fault probability ranking, the machine learning-based second fault probability ranking may include the N rank values respectively corresponding to the N programming elements.

In operation 240, the electronic device may determine a faulty programming element from among the programming elements based on a result of combining the rule-based first fault probability ranking with the machine learning-based second fault probability ranking. The combining may be performed by using a fault feature representing a feature of a fault occurring in the execution of the program.

The fault feature may be a feature of a fault (or an error) occurring from the execution of the program. The fault feature may represent a lifespan of a fault, the stability of the fault, and/or a fault type of the fault, for example.

The lifespan of a fault may correspond to, for example, the number of versions starting from a version where the fault newly occurred to a current version, among multiple versions of the program. For example, if a certain fault first occurs in a first version, and that certain fault also occurs in the second, third, and fourth versions (successive to the first version), and the fourth version is the current version, the lifespan of the certain fault may be determined to 4 based on the four consecutive versions having the fault.

The stability of a fault may be, for example, a ratio of failure to pass among all the test cases. For example, the electronic device may execute the program based on multiple test cases for verifying the program, and some of the test cases may fail to pass. The stability of a fault may be determined based on a ratio of the number of test cases having the fault that fail to pass to the number of all the test cases.

The fault type of a fault may be determined to be one of predetermined candidate fault types according to the characteristics of the fault. The candidate fault types may include an assert error type (e.g., the assert error type in the source code of the program or the assert error type in a test case), a hanging error type (or a timeout error type), a divided-by-zero error type, and/or a multi-error type, to name some non-limiting examples. The multi-error type may correspond to the occurrence of two or more errors or two or more types of errors.

As mentioned, the electronic device may combine the rule-based first fault probability ranking and the machine learning-based second fault probability ranking by using the fault feature. The electronic device may determine the ensemble-based third fault probability ranking by combining the rule-based first fault probability ranking with the machine learning-based second fault probability ranking. Like the rule-based first ranking and/or the machine learning-based second ranking, the ensemble-based third ranking may include N rank values respectively corresponding to the N programming elements. The electronic device may determine, from among the programming elements, a programming element to be a faulty element based on where ranking values of the third ranking. For example, programming elements with the smallest rank value(s) (corresponding to highest fault probabilities) in the third ranking (i.e., the topmost programming elements in the third ranking) to be fault elements.

The first and second rankings may be combined according to respective weights (ratios). The electronic device may determine a first weight for the rule-based first ranking and a second weight for the machine learning-based second ranking, based on the fault feature. The first weight may represent an importance level of the rule-based first ranking in the ensemble-based third ranking. Similarly, the second weight may represent an importance level of the machine learning-based second ranking in the ensemble-based third ranking. For example, as a value of the first weight increases, a contribution of the rule-based first ranking to the third rank may increase. Likewise, as a value of the second weight increases, a contribution of the machine learning-based second ranking to the third ranking may increase.

In some embodiments, the electronic device, based on the lifespan of a fault, may adjust the first weight or the second weight. The electronic device may increase the second weight as the number of versions from a version where the fault newly occurs to a current version increases.

In some embodiments, the electronic device, based on the fault type, may adjust the first weight or the second weight. For example, each candidate fault type may be mapped to a weight pair. The weight pair may include a value of the first weight and a value of the second weight. The electronic device may determine the fault type of a fault among the candidate fault types. The electronic device may determine the weight pair mapped to the determined fault type to the first weight and the second weight.

In some embodiments, the electronic device determining the weight pair mapped to the fault type of a fault to the first weight and the second weight is mainly described, however, embodiments are not limited thereto. For example, a candidate fault type may be mapped to an adjustment factor for the first weight or an adjustment factor for the second weight. The electronic device may adjust the first weight or the second weight by using the adjustment factor for the first weight or the adjustment factor for the second weight, mapped to the fault type of a fault, and may determine the first weight and the second weight by using the fault feature.

The electronic device may determine combined scores of the programming elements by using the rule-based first ranking, the machine learning-based second ranking, the first weight, and the second weight. The electronic device may determine the ensemble-based third ranking of the plurality of programming elements based on the combined scores of the programming elements.

For example, the electronic device, for each of the programming elements, may determine a first score for the rule-based first ranking and a second score for the machine learning-based second ranking and may determine the third ranking based on the first score and the second score.

For example, the electronic device, for each programming element, may determine a value obtained by multiplying the first weight by the reciprocal of a first rank value of a programming element of the rule-based first ranking to the first score of the programming element. The electronic device, for each programming element, may determine a value obtained by multiplying (i) the second weight by the reciprocal of a second rank value of a programming element of the machine learning-based second ranking with (ii) the second score of the programming element. The electronic device, for each programming element, may determine the ensemble-based third ranking by sorting a value (e.g., a combined score) obtained by summing the first and second scores of a programming element.

The electronic device may perform an operation (e.g., operations 210, 220, 230, and 240) to determine/identify the fault element based on a change request for changing the source code of the program.

In some embodiments, the electronic device may change at least a portion of the source code and may update (e.g., change or add to) a version of the program in response to receiving a change request for changing the source code. The electronic device may execute the program based on a test case after changing at least a portion of the source code. The electronic device, if a test case fails to pass, may determine the fault element. For example, the electronic device may determine the rule-based first ranking for the updated version of the program in response to a test case (e.g., at least one of the test cases) failing to pass. The electronic device may determine the machine learning-based second ranking for the updated version of the program in response to one of the test cases failing to pass. For example, the electronic device, in response to a test case (e.g., all of the test cases) passing, may skip determining the rule-based first ranking, the machine learning-based second ranking, and the fault element, and may determine that the updated version of the program does not have a fault.

In addition, the electronic device may perform an operation (e.g., operations 210, 220, 230, and 240) of determining a fault element based on an error report received from an external device. The external device be a device using the program. The external device may include, for example, an electronic device mounted to a vehicle and/or a user terminal (e.g., a smartphone, a tablet, or a computer).

The electronic device may determine the rule-based first ranking, the machine learning-based second ranking, and the fault element in response to receiving an error report for an error occurring in the program from the external device using the program.

The electronic device may output information about the determined fault element. For example, the electronic device may further include an outputter (e.g., a display) and may display information about the fault element to a user (e.g., a developer or a programmer) by visualizing the information on the fault element through the outputter. Based on the information about the fault element, the user may generate a change request to fix a fault of the program.

The electronic device may change at least a portion of the source code and may update a version of the program in response to receiving a change request for the source code. The electronic device may verify the updated version of the program. As described above with reference to FIG. 1, the electronic device, when executing the program based on test cases, may determine that the program is verified (e.g., the verification of the program is succeeded) if all the test cases pass, and may determine that the program is not verified (e.g., the verification is failed) if at least one test case fails to pass.

The electronic device may distribute information on the updated version of the program to the external device, based on the success in verifying the program. Information on the program may include information required to execute the program. For example, the information on the program may include the source code of the program and/or an execution file (e.g., a binary file) compiling the source code of the program.

FIG. 3 illustrates an example of determining a rule-based first ranking, according to one or more embodiments.

In operation 310, an electronic device may determine a rule-based probability score representing the probability that a corresponding programming element has a fault, and may do so based on whether a test case passes and whether the programming element was executed during the test case; this may be done for each of multiple programming elements.

The electronic device may execute a program based on multiple test cases and may determine the number of test cases classified into the same class according to whether a test case passes and whether a programming element is executed.

For example, the electronic device may, for a given programming element, determine a first number ep of test cases that pass when the given programming element is executed in the execution of the program based on the test cases. For the given programming element, the electronic device may also determine a second number ef of test cases that fail to pass when the given programming element is executed in the execution of the program based on the test cases. The electronic device may, for the given programming element, determine a third number np of test cases that pass when the given programming element is not executed in the execution of the program based on the test cases. The electronic device may, for the given programming element, determine a fourth number nf of test cases that fail to pass when the given programming element is not executed in the execution of the program based on the test cases. These metrics may be determined for each of the programming elements subject to testing. That is, values of ep, ef, np, and nf, may be determined for each of the programming elements. The metrics of the programming elements may be used to determine the rule-based probability scores of the respective programming elements.

For example, the electronic device may determine the rule-based probability score of a given programming element based on at least one of Equations 1 to 8 below.

$$\begin{matrix}rule \text{-} based possibility score = \frac{\frac{{e}_{f}}{{e}_{f} + {n}_{f}}}{\frac{{e}_{f}}{{e}_{f} + {n}_{f}} + \frac{{e}_{p}}{{e}_{p} + {n}_{p}}} & Equation 1 \\ rule \text{-} based possibility score = \frac{{e}_{f}}{\sqrt{( {e}_{f} + {e}_{p} ) ( {e}_{f} + {n}_{f} )}} & Equation 2 \\ rule \text{-} based possibility score = \frac{{e}_{f} {n}_{p}}{\sqrt{( {e}_{f} + {e}_{p} ) ( {n}_{f} + {n}_{p} ) ( {e}_{f} + {n}_{p} ) ( {n}_{f} + {e}_{p} )}} & Equation 3 \\ rule \text{-} based possibility score = {e}_{f} - \frac{{e}_{p}}{{e}_{p} + {n}_{p} + 1} & Equation 4 \\ rule \text{-} based possibility score = 1 - \frac{{e}_{p}}{{e}_{p} + {e}_{f}} & Equation 5 \\ rule \text{-} based possibility score = \frac{{e}_{f}}{{e}_{f} + {e}_{p} + {n}_{f}} & Equation 6 \\ rule \text{-} based possibilty score = \frac{{e}_{f}}{{n}_{f} + {e}_{p}} & Equation 7 \\ rule \text{-} based possibility score = \frac{{( {e}_{f} )}^{2}}{{e}_{p} + {n}_{f}} & Equation 8\end{matrix}$$

For example, the electronic device may determine a value calculated based on one of Equations 1 to 8 to be the rule-based probability score of the corresponding programming element, or may determine a value (e.g., a mean value or a median value) based on values calculated based on two or more of Equations 1 to 8 to be the rule-based probability score of the corresponding programming element.

In operation 320, the electronic device may adjust the rule-based probability scores of the respective programming elements based on a result of the execution of the program. The electronic device may adjust a probability score by multiplying a coefficient by the determined rule-based probability score. For example, the electronic device may increase the probability score by multiplying by a coefficient that is greater than 1. The electronic device may decrease the probability score by multiplying a coefficient that is between 0 and 1.

The result of the execution of the program may include an indication of whether a test case (obtained as the electronic device executes the test cases) passes, a call stack, the termination point of the test case, and/or whether there is any change compared to a previous version of the program, as non-limiting examples.

In some embodiments, when the test case fails to pass, the electronic device may increase the rule-based probability score of a programming element corresponding to a function that is indicated by the call stack of the program. When the test case fails to pass, the functions included in the call stack may have a high probability of having a fault.

The electronic device, by reflecting information in the call stack, when the test case fails to pass, may adjust (e.g., increase) the rule-based probability score of a programming element corresponding to the functions indicated by the call stack. The programming element corresponding to the functions may be, for example, the source code line(s) of the functions. The programming element be one or more of the functions, for example. As another example, the programming element corresponding to the functions may be a file that includes source code of the functions.

The electronic device may adjust the rule-based probability score of the programming element corresponding to the functions based on a position, in which information indicating the functions is stored, of the call stack. For example, the call stack may sequentially store the information indicating the functions according to a called order and/or a returned order of the functions. When the information indicating the functions is stored in the call stack, as a distance between a position where information indicating each function is stored and a top of the call stack decreases, the electronic device may adjust the rule-based probability score of the programming element corresponding to the functions by using a greater coefficient. In other words, the nearer a function is to the top of the call stack, the more weight may be given to the corresponding programming element.

According to an embodiment, the electronic device, when the test case fails to pass, may increase the rule-based probability score of a programming element corresponding to a termination point of the test case. The termination point may be a last execution point (e.g., a function or a line) in the source code when execution of the program for the test case terminates. Depending on a program design, the termination point may be a termination function or a termination line, for example.

According to an embodiment, when the test case fails to pass, the electronic device may increase the rule-based probability score of a programming element that is changed relative a previous version of the program. For example, when the test case fails to pass, the electronic device may increase the rule-based probability score of the changed programming element where a fault has occurred.

In operation 330, the electronic device may determine the rule-based first ranking by sorting, e.g., into increasing order, the adjusted rule-based probability scores; top ranking programming elements (low rank numbers) having the highest rule-based probability scores.

FIG. 4 illustrates an example of determining a machine learning-based second rank, according to one or more embodiments.

In some embodiments, an electronic device may determine a machine learning-based probability score 430 of a programming element by applying an element feature 410 of the programming element to a machine learning model 420.

The element feature 410 may represent an execution result of the programming element based on a test case. The electronic device, for each programming element, may obtain the element feature 410 representing at least one of a change history 411 of the corresponding programming element, a probability 412 that the corresponding programming element has a fault in a previous version of a program, a distance 413 between the programming element and a programming element that is changed relative to a previous version of the program on a call graph, an indication of a determination 414 of whether the programming element is executed in the execution of multiple versions of the program, and/or a rule-based probability score 415 of the programming element, to name some examples.

The element feature 410 may include the change history 411 of the programming element. When there are multiple versions of the program, the change history 411 of the programming element may include information about a version of the program in which source code of the programming element is changed compared to an even earlier version of the program. For example, based on a change request, the electronic device may obtain source code of a second version of the program by changing at least a portion of the source code of the programming element in a first version of the program. Based on a change of the source code of the programming element of the first version and the second version of the program, the electronic device may obtain the element feature 410 based on information on the first version and/or the second version.

The element feature 410 may also or alternatively include the probability 412 that the programming element has a fault. The electronic device may, for the first version of the program, determine ranks and/a probability scores representing the fault probabilities of respective programming elements. The electronic device may obtain the source code of the second version of the program by changing at least a portion of the source code of the first version of the program. The electronic device may, when obtaining/generating the element feature 410 of the corresponding programming element for a current version (e.g., the second version) of the program, include in the element feature 410a rank and/or a probability score of the programming element as calculated for a previous version (e.g., the first version) of the program.

The element feature 410 may additionally or alternatively include the distance 413 between its programming element and a programming element that is changed relative to a previous version of the program on a call graph.

A call graph represents call relationships among the programming elements (e.g., functions) included in the program (or the source code of the program). For example, each node of the call graph may be a function. An edge having a direction from a first node to a second node of the call graph represents a second function (represented by the second node) being directly called by a first function (represented by the first node).

The distance 413 between the programming element and a programming element that is changed relative to a previous version of the program on a call graph may be the number of edges between the first node of the call graph to which the changed programming element belongs and the second node of the programming element. For example, if there are multiple paths between the first node and the second node, the graph distance between them may be determined to be a reference distance (e.g., a mean value, a minimum value, or a median value) of distances of the paths.

The element feature 410 may also or alternatively include the indication of the determination 414 of whether the programming element is executed in the execution of the multiple versions of the program. The element feature 410 this indicate whether its programming element is executed when the multiple versions of the program are executed based on the test case. The element feature 410 may thus also include whether the versions have a fault.

The element feature 410 may also or alternatively include the rule-based probability score 415 (or a rank value of a rule-based rank) of the programming element. For example, the electronic device may obtain/generate the element feature 410 based on a rule-based probability score and/or a rule-based rank value of the programming element.

The electronic device may thus determine a rank value of a second rank of a programming element to a smaller value (e.g., a higher rank) as a machine learning-based probability score of each programming element has a greater value. That is to say, the element features of the respective programming elements may be passed to the machine learning model 420 which may infer the second ranks of the respective programming elements (the learning-based probability scores of the programming elements).

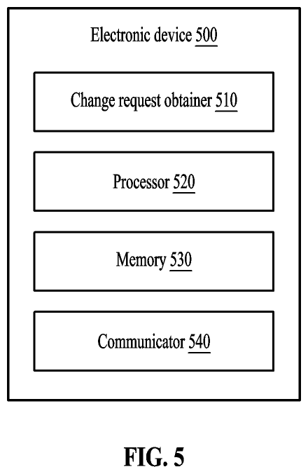

FIG. 5 illustrates an example electronic device, according to one or more embodiments.

According to an embodiment, an electronic device 500 may include a change request obtainer 510, a processor 520, a memory 530, and a communicator 540.

The change request obtainer 510 may obtain a change request for a source code of a program.

The processor 520 may execute the program based on a test case. The processor 520 may determine a rule-based first rank based on whether the test case passes and whether each programming element is executed. The processor 520 may determine a machine learning-based second rank based on a result of applying a machine learning model to an element feature representing the feature of a programming element. The processor 520 may determine a fault element among a plurality of programming elements based on a result of combining the first rank with the second rank by using a fault feature.

The memory 530 may temporarily and/or permanently store at least one of the test case, the plurality of programming elements, the source code, the program, whether the test case passes, whether each programming element is executed, the first rank, the machine learning model, the second rank, the fault feature, or the fault element. The memory 530 may store instructions for executing the program and determining the first rank, the second rank, and/or the fault element. However, the foregoing examples are just examples, and the information stored in the memory 530 is not limited thereto.

The communicator 540 may transmit and receive at least one of the test case, the plurality of programming elements, the source code, the program, whether the test case passes, whether each programming element is executed, the first rank, the machine learning model, the second rank, the fault feature, or the fault element to and from an external device (e.g., another electronic device or a server). The communicator 540 may establish a wired communication channel and/or a wireless communication channel with the external device (e.g., the electronic device and the server) and may establish communication with the external device via a long-range communication network, such as cellular communication, short-range wireless communication, local area network (LAN) communication, Bluetooth™, wireless-fidelity (Wi-Fi) direct or infrared data association (IrDA), a legacy cellular network, a fourth generation (4G) and/or 5G network, next-generation communication, the Internet, or a computer network (e.g., LAN or a wide area network (WAN)).

The computing apparatuses, the electronic devices, the processors, the memories, the displays, the information output system and hardware, the storage devices, and other apparatuses, devices, units, modules, and components described herein with respect to FIGS. 1-5 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-5 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method performed by an electronic device, the method comprising:
executing a program corresponding to source code, the program comprising instructions comprising programming elements, the executing based on a test case;
determining a rule-based first ranking of fault probability of the respective programming elements, based on whether the test case passes and based on whether each programming element is executed;
determining a machine learning-based second ranking of the programming elements based on a result of applying a machine learning model to element features of the respective programming elements; and
determining, from among the programming elements, a fault element, the determining based on a result of combining the rule-based first ranking with the machine learning-based second ranking, wherein the combining is based on a fault feature of a fault occurring in the execution of the program.

2. The method of claim 1, wherein the determining the rule-based first ranking comprises:
determining rule-based probability scores representing the probabilities that respective programming elements have a fault, based on whether the test case passes and whether the programming element is executed;
adjusting the rule-based probability scores of the respective programming elements based on a result of the execution of the program; and
determining the rule-based first ranking by sorting the adjusted rule-based possibility scores.

3. The method of claim 2, wherein the adjusting the rule-based possibility scores comprises:
when the test case fails to pass for a programming element, increasing the rule-based probability score of the programming element corresponding to a function that is indicated by a call stack of the program.

4. The method of claim 2, wherein the adjusting the rule-based probability scores comprises:
when the test case fails to pass, increasing a rule-based probability score of a programming element that corresponds to a termination point of the test case.

5. The method of claim 2, wherein the adjusting the rule-based probability scores comprises:
when the test case fails to pass, increasing a rule-based possibility score of a programming element that is changed compared to a previous version of the program.

6. The method of claim 1, wherein the determining the machine learning-based second ranking comprises:
obtaining element features of the programming elements, respectively;
inferring machine learning-based probability scores of the respective programming elements, wherein each machine learning-based probability score represents the probability that a corresponding programming element has a fault and is generated by applying the corresponding element feature to the machine learning model; and
determining the machine learning-based second ranking by sorting machine learning-based possibility scores.

7. The method of claim 6, wherein each of the element features comprises:
an indication of a change history of the corresponding programming element, a probability that the corresponding programming element has a fault in a previous version of the program, a call distance between the corresponding programming element and another programming element, an indication of whether the corresponding programming element is executed in the execution of versions of the program, or a rule-based probability score of the corresponding programming element.

8. The method of claim 1, wherein the combining comprises:
determining a first weight for the rule-based first ranking and a second weight for the machine learning-based second ranking; and
determining an ensemble-based third ranking of the programming elements by combining the rule-based first ranking and the machine learning-based second ranking according to the first and second weights.

9. The method of claim 8, wherein the second weight depends on a number of versions from a version where the fault newly occurs to a current version among versions of the program.

10. The method of claim 8, wherein the determining the first weight and the second weight comprises:
determining a fault type of the fault among candidate fault types; and
determining a weight pair mapped to the determined fault type to the first weight and the second weight.

11. The method of claim 1, wherein
the executing the program comprises:
changing the source code and updating a version of the program in response to receiving a change request for the source code; and
executing the program based on the test case after changing the source code, and
the determining the rule-based first ranking comprises:
determining the rule-based first ranking for the updated version of the program in response to the test case failing to pass, and
the determining the machine learning-based second ranking comprises:
determining the machine learning-based second ranking for the updated version of the program in response to at least one test case failing to pass.

12. The method of claim 1, wherein the method further comprises:
determining the rule-based first ranking, the machine learning-based second ranking, and the fault element in response to receiving an error report for an error occurring in the program from an external device using the program;
outputting information on the determined fault element;
changing the source code and updating a version of the program based thereon;
verifying the updated version of the program; and
distributing information on the updated version of the program to the external device, based on success in verifying the updated version of the program.

13. A non-transitory computer-readable storage medium storing instructions that, when executed by a processor, cause the processor to perform the method of claim 1.

14. An electronic device comprising one or more processors configured to:
execute a program corresponding to source code, the program comprising programming elements, the executing based on a test case,
determine rule-based first ranking of fault probabilities of the programming elements, based on whether the test case passes and based on whether each programming element is executed,
determine a machine learning-based second ranking of the programming elements based on a result of applying a machine learning model to element features of the respective programming elements, and
determine, from among the programming elements, a fault element,, the determining based on a result of combining the rule-based first ranking with the machine learning-based second ranking, wherein the combining is based on a fault feature of a fault occurring in the execution of the program.

15. The electronic device of claim 14, wherein the one or more processors are further configured to
determine rule-based probability scores representing the probabilities that programming elements have a fault, based on whether the test case passes and whether the programming element is executed,
adjust the rule-based probability scores of the respective programming elements based on a result of the execution of the program, and
determine the rule-based first ranking by sorting the adjusted rule-based probability scores.

16. The electronic device of claim 14, wherein the one or more processors are further configured to
obtain element features of the programming elements, respectively,
infer machine learning-based probability scores of the respective programming elements, wherein each machine learning-based probability score represents the probability that a programming element has a fault and is generated by applying the corresponding element feature to the machine learning model, and
determine the machine learning-based second ranking by sorting machine learning-based probability scores.

17. The electronic device of claim 14, wherein the one or more processors are further configured to
determine a first weight for the rule-based first ranking and a second weight for the machine learning-based second ranking, and
determine an ensemble-based third ranking of the programming elements by combining the rule-based first ranking and the machine learning-based second ranking according to the first and second weights.

18. The electronic device of claim 17, wherein the second weight depends on a number of versions from a version where the fault newly occurs to a current version among versions of the program.

19. The electronic device of claim 14, wherein the one or more processors are further configured to
change the source code and update a version of the program in response to receiving a change request for the source code,
execute the program based on the test case after changing the source code,
determine the rule-based first ranking for the updated version of the program in response to the test case failing to pass, and
determine the machine learning-based second ranking for the updated version of the program in response to at least one test case failing to pass.

20. The electronic device of claim 14, wherein the one or more processors are further configured to
determine the rule-based first ranking, the machine learning-based second ranking, and the fault element in response to receiving an error report for an error occurring in the program from an external device using the program,
output information on the determined fault element,
change the source code and update a version of the program based thereon,
verify the updated version of the program, and
distribute information on the updated version of the program to the external device, based on success in verifying the updated version of the program.
